(19) United States
(12) Patent Application Publication
(10) Pub. No.: US 2009/0078064 A1
(43) Pub. Date: Mar. 26, 2009

(54) INSTRUMENT FOR SIMULTANEOUS ANALYSIS OF MULTIPLE SAMPLES USING MULTIPLE DIFFERENTIAL MOBILITY ANALYZERS

(76) Inventor: Abraham Oommen, Lincoln, NE (US)

Correspondence Address: HUSCH BLACKWELL SANDERS LLP, 1620 DODGE STREET, SUITE 2100, OMAHA, NE, 68102, US

(21) Appl. No.: 12/187,054

(22) Filed: Aug. 6, 2008

Related U.S. Application Data
(60) Provisional application No. 60/954,239, filed on Aug. 6, 2007.

(51) Int. Cl. G01N 15/02

(52) U.S. Cl. 73/865.5

(57) ABSTRACT

A differential mobility analyzer that is capable of analyzing more than one sample simultaneously, comprising an aerosol generator, a particle classifier and/or a particle counter is disclosed.

### CROSS REFERENCE TO RELATED APPLICATIONS

This application claims the benefit of and priority to U.S. Provisional Patent Application No. 60/954,239 filed Aug. 6, 2007, entitled INSTRUMENT FOR SIMULTANEOUS ANALYSIS OF MULTIPLE SAMPLES USING MULTIPLE DIFFERENTIAL MOBILITY ANALYZERS which document is hereby incorporated by reference to the extent permitted by law.

### BACKGROUND OF THE INVENTION

Several types of devices have been developed for analyzing particles of uniform size (monodisperse) or various sizes (polydisperse) as long as these particles are aerosols. The differential mobility analyzer (DMA) is the standard device used for measuring size distribution of nanometer aerosols based on their electrical mobility in air or other gases. Though developed in the 1970s, primarily for analyzing particles suspended in the atmosphere, DMAs are now used in semiconductor, analytical chemistry, pharmaceutical, health care and life science applications. One such DMA has been generally described by Pui, in U.S. Pat. No. 6,230,572. The use of DMAs and other particle classifiers, though not common is slowly gaining momentum in life science applications. Whatever the case may be, the use of DMAs has been limited to single DMAs through which aerosols are passed and then classified according to the size of the particles in the aerosols. This means that a single sample is analyzed each time and is followed by another sample until all samples are analyzed serially, one after the other.

Typically this involves manually loading the device, one sample at a time. The developing areas of life sciences referred to as proteomics, metabolomics and nutrigenomics require the simultaneous analysis of multiple samples while at the same time analyzing and interpreting multiple proteins, other macromolecules and the interaction of various chemical and non-chemical entities with proteins from each sample. Additionally, clinical diagnostic requirements of the future will require simultaneous detection, analysis and classification of numerous markers like antibodies, antigens, pathogens etc from a single sample, like blood or urine along with the ability to analyze multiple samples at the same time.

Accordingly, it is one of the objectives of the present invention to provide a differential mobility analyzer and related instrumentation and systems that is capable of multiple sample analysis and the analysis of multiple components within the sample at the same time.

Another objective of the present invention is to provide an integrated automated sampler, aerosol generation system, differential mobility analyzer and particle counter that are capable of analyzing multiple samples at the same time and working as a single unit.

A further objective will be to provide an array of differential mobility analyzers that are capable of independent sample analysis simultaneously. The parallel array of DMAs could be 2, 4 or multiples or additions thereof or any combinations of DMAs plus one.

A further objective will be to provide an array of aerosol generation systems, differential mobility analyzers and particle counters in various combinations of more than 1 for each and it could be 2, 4 or multiples or additions thereof or any combinations plus one.

Yet another objective will be to provide a differential mobility analyzer that is an array of DMAs but with each DMA with different or uniform resolution and analysis capabilities.

### SUMMARY

Some embodiments relate to a differential mobility analyzer that is capable of analyzing more than one sample simultaneously, comprising an aerosol generator, a particle classifier and/or a particle counter. Other embodiments relate to further refinements of the DMA system.

### BRIEF DESCRIPTION OF THE DRAWINGS

FIG. 1 is a schematic of a DMA apparatus.

FIG. 2 is a schematic of another DMA apparatus.

### DESCRIPTION

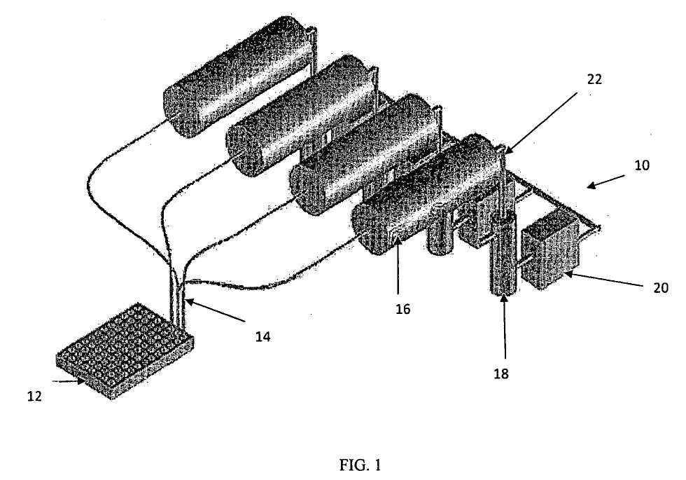

To achieve the objectives stated here as well as other objectives, a device has been designed that is referred to henceforth as a multichannel DMA. Referring to FIG. 1, the multichannel DMA system 10 will be able to resolve polydisperse aerosols in a gaseous medium. System 10 includes a multi-well plate 12, an auto-sampler conduit 14, an aerosol generator 16, a differential mobility analyzer (DMA) 16, a condensation particle counter 18, and an in-let conduit for aerosol 20. In some embodiments, the apparatus may include four DMAs 12 connected in parallel in which the sheath gas conduit is a single tube out of each independent DMA but connected to a common conduit that supplies the sheath gas. FIG. 1 shows a schematic of this device. In some embodiments, the aerosol generator may be an electro spray aerosol generator.

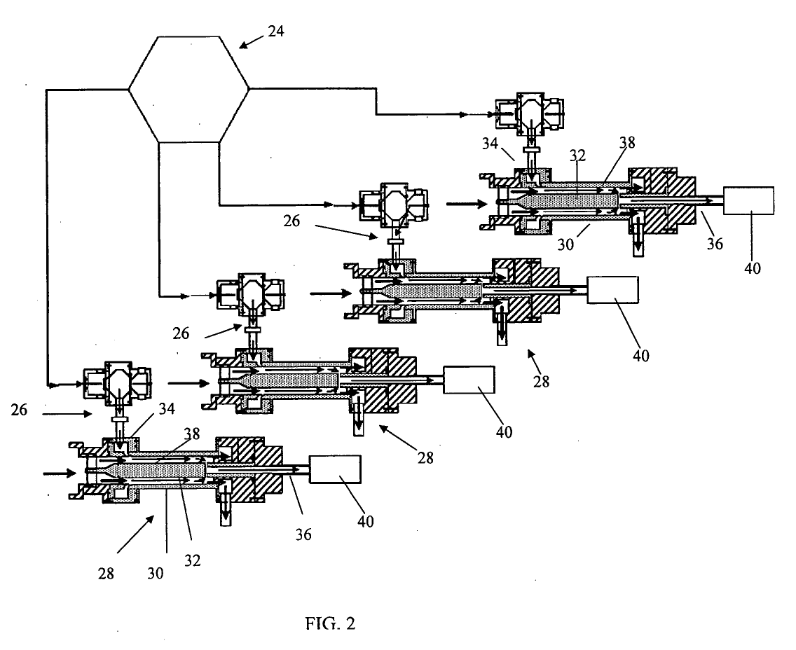

Valves and other controlling elements may be used to provide uniform pressure and flow of sheath gas through each DMA, though each parameter can be varied for any particular DMA. The conduit on the DMA that is the intake for sample aerosols is connected to independent aerosol generating devices. In some embodiments the aerosol generating device may be an electrospray device capable of generating aerosols. As shown in FIG. 1, each independent aerosol generating device is connected through a conduit to an auto-sampler with the ability to independently collect four samples simultaneously from a multi-well plate and is capable of delivering the sample to the aerosol generating device. A multi-well plate is shown in FIG. 1 to illustrate this. In FIG. 2, an embodiment comprising the concept of an autosample is shown but indicated as a sample injector. The cylindrical DMAs have collection apertures which are connected through a conduit to another device that deposits, measures some set parameters or in typical cases, counts the number of particles collected. In the present embodiment, a condensation particle counter is connected to each DMA collection aperture. The particle counters will have common air flow as well as common exhausts along with controls that allow parallel common commands as well as independent operations. The entire system may function as one instrument and may be capable of automated operation.

Referring to FIG. 2, a system may include a sample injector 24. Though the device is shown as a sample injector, it may comprise any device or assembly that allows the delivery of samples from a sample collection (like samples in tubes to samples in plates, i.e., samples in 96 well plates or more than 96 wells like 384 wells etc). Whatever the way the samples are presented to them (in plates or tubes), the sample injector's role is to draw up the sample into small diameter tubes and then inject the samples into the Electrospray device 26. The samples in tubes can be drawn up using suction (using pumps) or through pressure (using another tube in the sample to apply pressure to move the sample up a second tube). The sample may then be injected into the electrospray device using the sample pump mechanism. In some embodiments, the sample injector will have the ability to draw up one sample or multiple samples (in groups of four). The sample injector will have the capacity to draw up samples (liquid) and then inject the samples into the electrospray device. In one embodiment, the capacity to draw the samples is in multiples, for example, of four or eight or more. The pumps may be programmable in that volume drawn up and moved through the system can be controlled. The injector has inlets and outlets that are controlled by valves. There are valves that allow the closure of the outlet tubes and the opening of another separate outlet to allow washing or cleaning (rinsing) of the inlet tubes between each sample injection. Since the injector is a programmable device, it can have capabilities like range of sample volumes (from 10 ul to 100 ul per injection or any other volume that is needed) or continuous flow. The entire injector can be stationary and attached to the electrospray 26 or it can be attached to a movable platform. In the first instance, the samples would come to the device on a movable platform. In the second instance, the sample injector would move to the sample tray.

DMA 28 is the instrument used for sizing the aerosol. The instrument is in simplistic forms, just two charged concentric cylinders 30 and 32 with an inlet slot 34 and a sampling or exit slot 36. The inlet slot allows samples to be delivered as aerosols into the device. The DMA actually separates particles based on their electrical mobility. Aerosol particles for sizing are injected into the annular region 38 between the two cylinders at the inlet slot. This is typically done using an aerosol generating device, like the Electrospray 26. The aerosols are carried by clean air flowing through the annular region 38 (referred to as sheath air). Particles with mobilities in a certain narrow range are sampled at the exit slot. Particles that go through the sampling slit are usually counted using a particle counter 40 like a condensation particle counter (CPC) or other devices including an electrometer. The particle counter gives an estimate of the total number of particles of a particular flow range that exited the exit slot. Before that, an inversion calculation is done to infer the size distribution of the particles. The sizing depends on certain adjustable parameters such as the voltage, the flow rates, etc.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

The terminology used in the description of the invention herein is for the purpose of describing particular embodiments only and is not intended to be limiting of the invention. As used in the description of the embodiments of the invention and the appended claims, the singular forms “a”, “an” and “the” are intended to include the plural forms as well, unless the context clearly indicates otherwise.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that relative terms are intended to encompass different orientations of the device in addition to the orientation depicted in the Figures.

Moreover, it will be understood that although the terms first and second are used herein to describe various features, elements, regions, layers and/or sections, these features, elements, regions, layers and/or sections should not be limited by these terms. These terms are only used to distinguish one feature, element, region, layer or section from another feature, element, region, layer or section. Thus, a first feature, element, region, layer or section discussed below could be termed a second feature, element, region, layer or section, and similarly, a second without departing from the teachings of the present invention.

It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Further, as used herein the term “plurality” refers to at least two elements. Additionally, like numbers refer to like elements throughout. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow. The scope of the disclosure is not intended to be limited to the embodiments shown herein, but is to be accorded the full scope consistent with the claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims.

What is claimed is:

1. A DMA apparatus that is capable of analyzing more than one sample simultaneously, comprising an aerosol generator, a particle classifier and/or a particle counter.

2. The DMA apparatus of claim 1 comprising a plurality of one or more of an aerosol generator, a particle classifier and/or a particle counter (e.g., one aerosol generator connected to 4 particle classifiers which are connected to one condensation particle counter or other combination of multiple of one aerosol generator, particle classifier, or particle counter with multiple of the other of the aerosol generator, particle classifier, or particle counter).

3. The DMA apparatus of claim 1 where in the aerosol generator is a particle charging device

4. The DMA apparatus of claim 3 wherein the particle charging device is an electrospray ionization device,

5. The DMA apparatus of claim 4 wherein the electrospray ionization device is a nanospray or microspray device.

6. The DMA apparatus of claim 1 where the aerosol generator is an atomizer

7. The DMA apparatus of claim 1 where the aerosol generator is a pulse generation or droplet generation device

8. The DMA apparatus of claim 1 where the number of aerosol generators connected equal to the number of particle classifiers

9. The DMA apparatus of claim 1 where the number of aerosol generators are not equal to the number of particle classifiers

10. The DMA apparatus of claim 1 where the particle classifier is a differential mobility analyzer

11. The DMA apparatus of claim 1 where the particle classifier is a nanometer differential mobility analyzer

12. The DMA apparatus of claim 1 where the particle classifier is a micro-differential mobility analyzer

13. The DMA apparatus of claim 1 where the particle classifier is a lab-on-a-chip type differential mobility analyzer

14. The DMA apparatus of claim 1 where the particle counter is a condensation particle counter

15. The DMA apparatus of claim 1 where the particle counter is a light scattering device

16. The DMA apparatus of claim 1 where the particle counter is a laser particle counter

17. The DMA apparatus of claim 1 where the particle counter is an electrometer
